(19) United States
(12) Patent Application Publication
(10) Pub. No.: US 2012/0126819 A1
(43) Pub. Date: May 24, 2012

(54) DETECTING DEVICE AND METHOD FOR DETECTING BATTERY STORAGE CAPACITY

(75) Inventors: CHENG-PING LIU, Taoyuan (TW); CHIA-FENG WU, Taoyuan (TW)

(73) Assignee: FOXCONN COMMUNICATION TECHNOLOGY CORP., Taoyuan County (TW)

(21) Appl. No.: 13/094,765

(22) Filed: Apr. 26, 2011

(30) Foreign Application Priority Data
Nov. 24, 2010 (TW) 99140473

(51) Int. Cl. G01N 27/416

(52) U.S. Cl. 324/427

(57) ABSTRACT

A detecting device used to detect storage capacity of a battery is connected to a load by a first output terminal and a second output terminal. The detecting device includes a switch unit, a detecting unit, and a control unit. The switch unit is connected between the first and second output terminals. The detecting unit is connected to the first and second output terminals. The detecting unit detects output voltage and current of the battery when the switch is turned on and off and obtains an internal resistance of the battery according to the detected output voltage and current. The control unit controls the switch unit to turn on and off and compares the detected resistance with a reference resistance, and determines the storage capacity of the battery according to the comparison.

### BACKGROUND

1. Technical Field

The disclosure generally relates to detecting devices and methods, and particularly to a detecting device and method for detecting storage capacity of a battery.

2. Description of Related Art

Internal resistance of a battery increases with age which leads to decrease in storage capacity. Therefore, the time needed to charge the battery is shortened; however, the device using the battery may still charge a standard charging time and overcharge the battery.

Therefore, there is room for improvement within the art.

### BRIEF DESCRIPTION OF THE DRAWINGS

Many aspects of the detecting device and method for detecting storage capacity of battery can be better understood with reference to the following drawings. The components in the drawings are not necessarily drawn to scale, the emphasis instead being placed upon clearly illustrating the principles of the detecting device and method for detecting storage capacity of battery.

FIG. 1 shows a detecting device used to detect storage capacity of a battery, according to an exemplary embodiment.

FIG. 2 is a partial circuit diagram of one embodiment of the detecting device of FIG. 1, when the detecting device is connected to the battery, and a switch unit of the detecting device is turned off.

FIG. 3 is similar to FIG. 2 but with the switch unit turned on.

### DETAILED DESCRIPTION

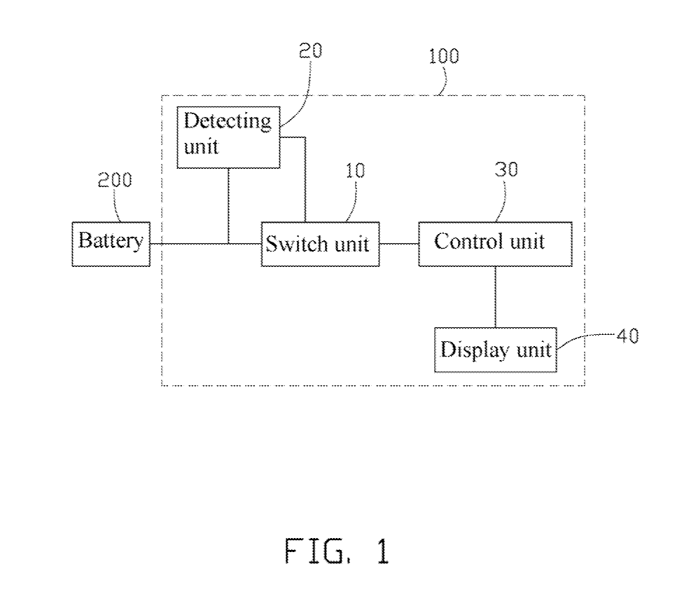

FIG. 1 shows a detecting device 100 used to detect a storage capacity of a battery 200, according to an exemplary embodiment. The detecting device 100 includes a switch unit 10, a detecting unit 20, a control unit 30, and a display unit 40 connected in series, and the switch unit 10 is also connected to the control unit 30.

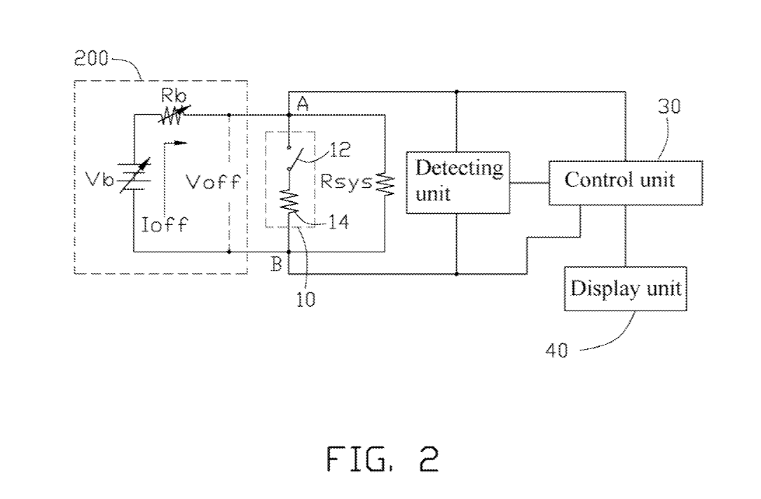

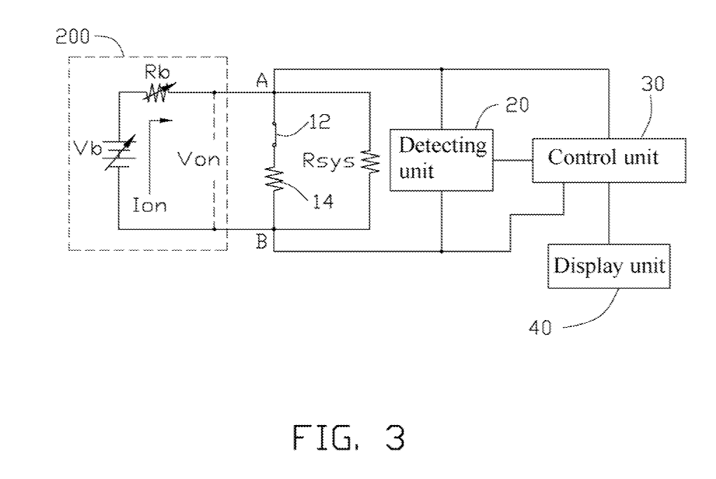

Referring to FIGS. 2 and 3, an equivalent circuit of the battery 200 includes a voltage source Vb and an internal resistor Rb connected in series. The battery 200 is connected to a load Rsys by a first output terminal A and a second output terminal B. The battery 200 provides electrical power to the load Rsys. The load Rsys may be an electronic element such as a CPU, a speaker, for example, of a portable electronic device.

The switch unit 10 includes a switch 12 and a resistor 14. The switch 12 and the resistor 14 are connected in series between the first output terminal A and the second output terminal B. When the switch 12 is turned off, the load Rsys forms a circuit loop with the battery 200. When the switch 12 is turned on, the resistor 14 is connected in parallel with the load Rsys and the battery 200. The switch 12 may be a diode.

The detecting unit 20 is connected to the first output terminal A and the second output terminal B. The detecting unit 20 detects output voltages and current of the battery 200 when the switch 12 is turned on and off and obtains the detected resistance of the internal resistor Rb (i.e. the internal resistance of the battery 200) according to the detected output voltages and current.

The control unit 30 is connected to the first output terminal A and the second output terminal B. The control unit 30 controls the switch 12 to turn on and off. A reference resistance of the internal voltage is preset in the control unit 30. The control unit 30 compares the detected resistance of the internal resistor Rb received from the detecting unit 20 with the reference resistance and determines a present storage capacity and a preferred charge time associated with the determined present storage capacity of the battery 200 according to the comparison.

The display unit 40 receives and displays the present storage capacity and the associated preferred charge time data of the battery 200 from the control unit 30.

To detect a capacity (i.e., the current storage capacity) of the battery 200 with the detecting device 100, the switch unit 10 and the detecting unit 20 are connected to the battery 200 by the first output terminal A and the second output terminal B. The control unit 30 controls the switch 12 to turn on. The load Rsys forms a circuit loop with the battery 200. In this case, the output voltage and current of the battery 200 are defined as Voff and Ioff. The detecting unit 20 detects the output voltage Voff and the output current Ioff.

Next, the control unit 30 controls the switch 12 to turn off. The internal resistor 14 is connected to the load Rsys in parallel. In this case, the output voltage and current of the battery 200 are defined as Von and Ion. The detecting unit 20 detects the output voltage Von and the output current Ion. The voltage source Vb can be computed using a formula (Vb−Von)/Ion=(Vb−Voff)/Ioff. Furthermore, the internal resistor Rb can be obtained using a formula Rb=(Vb−Von)/Ion=(Vb−Voff)/Ioff=(Voff−Von)/(Ion−off). The control unit 30 compares the detected internal resistance of the battery 200 with the reference resistance, and determines the storage capacity and the associated preferred charge time of the battery 200 according to the comparison. The display unit 40 displays the storage capacity and the preferred charge time data of the battery 200

The detecting device 100 obtains the internal resistance of the battery 200 according to the detected output voltages and current, and further determines the storage capacity and the preferred charge time of the battery 200 by comparing the internal resistance with the reference resistance, thus, overcharging of the battery 200 can be prevented.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A detecting device used to detect storage capacity of a battery which is connected to a load by a first output terminal and a second output terminal; the detecting device comprising:
a switch unit connected between the first output terminal and the second output terminal;
a detecting unit connected to the first output terminal and the second output terminal and detecting output voltage and current of the battery when the switch is turned on and off and obtaining an internal resistance of the battery according to the detected output voltage and current; and
a control unit controlling the switch unit to turn on and off and comparing the detected resistance with a reference resistance, and determining the storage capacity of the battery according to the comparison.

2. The detecting device as claimed in claim 1, wherein the switch unit includes a switch and a resistor connected in series.

3. The detecting device as claimed in claim 2, wherein when the switch is turned off, the battery forms a circuit loop with the load.

4. The detecting device as claimed in claim 2, wherein when the switch is turned on, the resistor is connected in parallel with the load.

5. The detecting device as claimed in claim 1, further includes a display unit connected to the control unit to display the storage capacity.

6. A method for detecting storage capacity of a battery which is connected to a load by a first output terminal and a second output terminal; comprising:
providing a switch unit connected to the first output terminal and the second output terminal;
detecting output voltage and current of the battery when the switch unit is turned on and off;
obtaining an internal resistance of the battery according to the detected output voltage and current;
comparing the detected resistance with a reference resistance; and
determining the storage capacity of the battery according to the comparison.

7. The method as claimed in claim 6, wherein the switch unit includes a switch and a resistor connected in series.

8. The method as claimed in claim 7, wherein when the switch is turned off, the battery forms a circuit loop with the load.

9. The method as claimed in claim 7, wherein when the switch is turned on, the resistor is connected in parallel with the load.

10. The method as claimed in claim 6, further includes displaying the storage capacity data.
